(19) United States
(12) Patent Application Publication
(10) Pub. No.: US 2006/0198780 A1
(43) Pub. Date: Sep. 7, 2006

(54) Method and apparatus for removing CO2 in mixed gas such as biogas

(75) Inventor: Masaaki Ota, Kyoto (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SHIMADZU CORPORATION, Kyoto-shi (JP)

(21) Appl. No.: 11/365,818

(22) Filed: Mar. 2, 2006

(30) Foreign Application Priority Data
Mar. 3, 2005 (JP) 2005-059395

(51) Int. Cl. C01B 31/18; B01D 53/34; B01D 50/00

(52) U.S. Cl. 423/418.2; 422/168; 422/169; 422/170; 422/173

(57) ABSTRACT

The CO₂ removing apparatus includes a first reaction flow path and a second reaction flow path. The first reaction flow path includes a first reaction section in which a supplied gas is heated in the presence of a catalyst to cause a reaction, a raw material gas supply section supplying a raw material gas containing at least CH₄ and CO₂ to the first reaction section, a cooling unit for removing H₂O from a mixed gas of a reaction product in the first reaction section, and a circulation flow path mixing the mixed gas passing through the cooling unit into the raw material gas to again supply the mixed gas to the first reaction section. The second reaction flow path is connected to the first reaction flow path so that part of the mixed gas is supplied thereto and includes a second reaction section that is heated in the presence of another catalyst to thereby react CO₂ and CO with H₂ in the mixed gas and to convert CO₂ and CO to CH₄.

### FIELD OF THE INVENTION

The invention relates to a method and an apparatus for removing CO₂ in a mixed gas containing at least CH₄ and CO₂ such as a biogas generated by anaerobic methane fermentation of organic materials.

### BACKGROUND ART

A biogas contains methane (CH₄), carbon dioxide (CO₂), and water (H₂O) of a high concentration. In order to extract CH₄ from a biogas to use it as a raw material for hydrogen production or for synthesis of organic compounds, it is necessary to separate and remove CO₂ from the biogas. The PSA (Pressure Swing Absorption) method and a method using a separation film have been employed as a method removing CO₂ and H₂O from the biogas.

In the PSA method, the following steps are repeated successively: an adsorption step of supplying a raw material gas into a tower packed with an adsorbent such as activated charcoal, molecular sieve activated charcoal, natural zeolite, synthetic zeolite, silica gel or activated alumina to adsorb carbon dioxide and water, which are easily adsorbed components, and to thereby collect methane; and a step of reactivating the adsorbent, to which carbon dioxide and water have been adsorbed, by reducing a pressure in the tower to thereby desorb the easily adsorbed components (see JP-A No. 2004-300035).

### DISCLOSURE OF THE INVENTION

In a case where CO₂ is removed from a mixed gas such as a biogas as a raw material gas, a problem arises that the PSA method requires an extremely large facility, while the method using a separation film takes time excessively because of its low efficiency, in order to handle a great quantity of the raw material gas.

Further, there has been no use of carbon dioxide removed through these methods, and it has been wasted into the air.

It is an object of the invention to provide a CO₂ removing method and apparatus capable of not only treating a great quantity of a raw material gas even with a facility smaller on a scale as compared with a case of the PSA method and treating the raw material gas in time shorter than in the separation film method, but also suppressing a quantity of CO₂ wasted into the air.

The invention is a CO₂ removing method removing CO₂ in a raw material gas containing at least CH₄ and CO₂, and comprises the following processes:

(A) a first reaction process to constitute a circulation flow path including: a step of supplying the raw material gas to a first reaction section heated in the presence of a catalyst containing a transition metal as a catalyst active component; a step of removing H₂O from a mixed gas which is a reaction product in the first reaction section; and a step of again supplying the mixed gas from which H₂O has been removed, being mixed with the raw material gas, into the first reaction section, and

(B) a second reaction process in which part of the mixed gas is taken out from the downstream of the first reaction section and supplied into a second reaction section heated in the presence of another catalyst containing a transition metal as a catalyst active component to thereby react CO₂ and CO with H₂ in the mixed gas to convert the former reactants to CH₄.

The mixed gas which is a reaction product of the first reaction section, from which H₂O is removed, is typically a mixed gas containing CH₄, H₂, CO and CO₂.

The mixed gas to be supplied into the second reaction section is preferably the mixed gas which is the reaction product of the first reaction section, from which H₂O is removed.

Transition metal catalysts have been known as catalysts for reactions in which carbon oxide or hydrocarbons are a part of. Among transition metals, Fe, Co and Ni are catalyst components well used. A transition metal catalyst is used as the catalyst in not only the first reaction process but also in the second process of the invention and at least one kind selected from the group consisting of Fe, Co and Ni is preferably used. The catalyst may be a metal alone, but in order to increase a surface area as generally adopted, it is preferable to use the metal in a state of being supported on a support Silica or alumina is preferably used as such a support

One example of a raw material gas of the invention is a biogas generated by anaerobic methane fermentation of organic materials.

In the first reaction process, CH₄ and CO₂ in the introduced raw material gas react with each other under the action of the catalyst The following reaction formulae (1) to (3) are included in the reaction.
CH₄+CO₂″2C+2H₂O (1)
CH₄+CO₂→2CO+2H₂ (2)
CO₂+C→2CO (3)

Depending on conditions, a solid carbon is generated as a reaction product, wherein the generated carbon deposits and is fixed on the catalyst or on the neighborhood thereof. Further, the generated H₂O can be taken out of the reaction system by cooling it As a result, the gas introduced from the first reaction process to the second reaction process becomes a mixed gas containing CH₄, H₂, CO and unreacted CO₂.

In the second reaction process, CO, CO₂ and H₂ in the introduced mixed gas react with each other as shown in the following reaction formulae (4) and (5) to thereby convert CO and CO₂ to CH₄ and suppress CO₂ wasted out of the system.
3H₂+CO→CH₄+H₂O (4)
4H₂+CO₂→CH₄+2H₂O (5)

Since H₂O generated in the second reaction process can also be taken out of the system by cooling it, a gas with high concentration of CH₄ can be extracted from the raw material gas, which contains CH₄ and CO₂ such as a biogas, by removing CO₂.

A CO₂ removing apparatus of the invention comprises a first reaction flow path carrying out the first reaction process and a second reaction flow path carrying out the second reaction process. The first reaction flow path includes: a first reaction section in which a supplied gas is heated in the presence of a catalyst containing a transition metal as a catalyst active component to cause a reaction; a raw material gas supply section supplying a raw material gas containing at least CH₄ and CO₂ to the first reaction section; a cooling unit set downstream of the first reaction section and removing H₂O from a mixed gas, which is a reaction product in the first reaction section; and a circulation flow path mixing the mixed gas passing through the cooling unit into the raw material gas to again supply the mixed gas to the first reaction section. The second reaction flow path is connected to the first reaction flow path so that part of the mixed gas, which is a reaction product in the first reaction flow path, is supplied thereto and includes a second reaction section that is heated in the presence of another catalyst containing a transition metal as a catalyst active component to thereby react CO₂ and CO with H₂ in the mixed gas and to convert CO₂ and CO to CH₄.

It is preferable that the second reaction flow path is connected to a position downstream of the cooling unit of the first reaction flow path and upstream of a merging section with the raw material gas supplying section, and the mixed gas from which H₂O has removed is supplied thereto.

In the CO₂ removing method and apparatus of the invention, a mixed gas containing CH₄, H₂, CO and CO₂ is obtained from a raw material containing CO₂ and CH₄ in the first reaction process, and in the second reaction process, CO and unreacted CO₂ are reacted so as to be converted to CH₄ and H₂O using a catalyst Since a reaction in the invention is a reaction using a catalyst, even in a case where a great quantity of a raw material gas is treated, the treatment can be achieved in a small facility in a short time.

Since carbon dioxide in a raw material gas is converted to CH₄ and even if some of it is further converted to carbon, the carbon is fixed and removed, and CO₂ wasted into the outside air is suppressed in quantity. Methane can be used as a material for organic synthesis, for hydrogen production used in a fuel cell and for a fuel, and even if carbon were to be produced, it can also be used as a conductive industrial material.

### BRIEF DESCRIPTION OF THE DRAWING

FIG. 1 is a flow path diagram schematically showing a construction of a CO₂ removing apparatus as one example.

### DESCRIPTION OF THE PREFERRED EXAMPLES

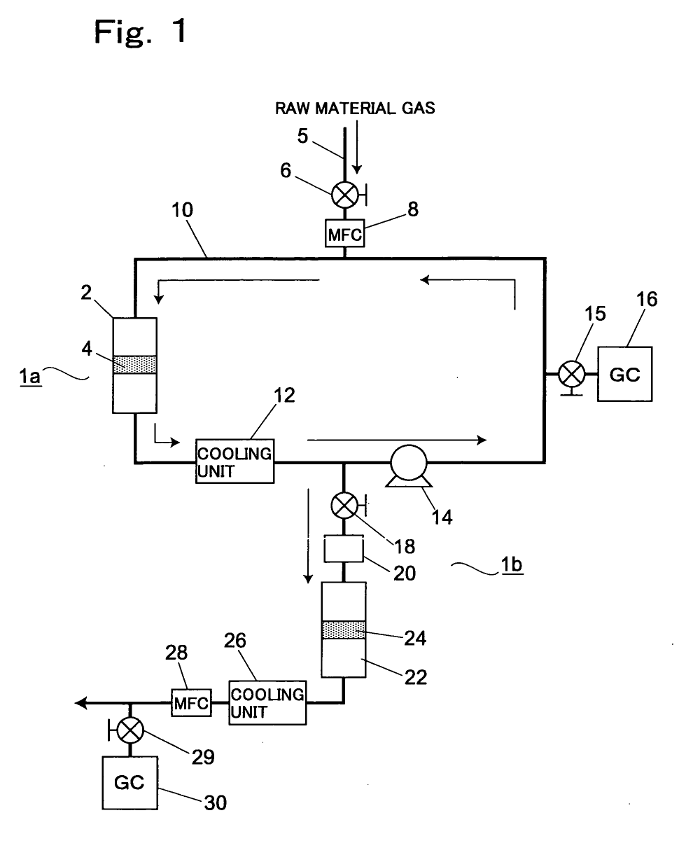

Description of a preferred embodiment of the invention will be given with a reference to the accompanying drawing. FIG. 1 is a flow path diagram schematically showing a construction of a CO₂ removing apparatus as one example.

The CO₂ removing apparatus includes a first reaction flow path 1a and a second reaction flow path 1b. The first reaction flow path 1a has a loop-like flow path 10 and the flow path 10 constitutes a circulation flow path circulating a gas provided with a pump 14. A raw material gas introduction flow path 5 is connected to the flow path 10 in order to supply a raw material gas containing at least CH₄ and CO₂ such as a biogas. A mass flow controller 8, for adjusting a raw material gas flow rate supplied through a valve 6, is provided in the raw material gas introduction flow path 5. A raw material gas supply section is constituted of the raw material gas introduction flow path 5, the valve 6, and the mass flow controller 8.

The flow path 10 is provided with the first reaction section 2, just downstream of a connection position with the raw material gas introduction flow path 5, in which the raw material gas is reacted by being heated in the presence of a catalyst 4 containing a transition metal as a catalyst active component to generate CO, H₂ and H₂O. In the first reaction section 2, carbon C is generated depending on conditions. A cooling unit 12, for removing H₂O from the reaction product in the first reaction section 2 is installed downstream of the first reaction section 2. The flow path 10 is used as a circulation flow path for mixing a mixed gas passing through the cooling unit 12 with a raw material gas supplied from the raw material gas introduction flow path 5 and for again supplying the mixed gas to the first reaction section 2.

The catalyst 4 packed in the interior of the first reaction section 2 is a catalyst for causing the reaction shown by the formulae 1 to 3 and may be regarded as a CO₂ fixation catalyst The catalyst 4 is a Ni/SiO₂ catalyst having Ni as a catalyst component carried on a silica (SiO₂) support and kept in the first reaction section 2 using a gas permeable material such as quartz wool, and a gas flows through gaps in the catalyst In this apparatus, a packed quantity of the catalyst 4 is from 1 to 2 g. The packed quantity of the catalyst 4 is properly set according to a scale of the reaction apparatus or a gas flow rate to be treated. A heating furnace for heating the catalyst 4 is provided around the first reaction section 2 and the catalyst 4 is heated at a predetermined temperature between 550 to 600° C.

In the first reaction section 2, CO, H₂ and H₂O are generated as reaction products and carbon may be generated depending on conditions. Carbon is deposited as a solid on a catalyst or in the neighborhood thereof. A gas exiting from the first reaction 2 contains CO, H₂ and H₂O, and in addition thereto, unreacted CO₂. The cooling unit 12 is provided downstream of the first reaction section 2 in order to remove water from the gas.

A branch flow path branched from the flow path 10 is provided at a position downstream of the cooling unit 12 and upstream of the connection position with the raw material gas introduction flow path 5 and a gas chromatograph 16 is provided through a closing valve 15 in the branch flow path. A mixed gas, after water is removed in the cooling unit 12, is sampled at constant intervals or as occasion calls with the closing valve 15 and components of the mixed gas are analyzed by the gas chromatograph 16.

A second reaction flow path 1b is connected to the flow path 10 at a position downstream of the cooling unit 12 and upstream of the connection position with the raw material gas introduction flow path 5 through a closing valve 18 and a mass flow controller 20 for adjusting a flow rate.

A second reaction flow path 1b is equipped with a second reaction section 22 for reacting CO₂ and CO with H₂ in a mixing gas extracted from the first reaction flow path 1a by heating in the presence of a catalyst 24 containing a transition metal as a catalyst active component to convert the CO₂ and CO in the mixed gas to CH₄. The catalyst 24 packed in the interior of the reaction section 22 is a catalyst for causing the reaction shown by the formulae 4 and 5 and may be regarded as a methanation catalyst for producing methane. The catalyst 24 is a Ni/SiO₂ catalyst having Ni as a catalyst component supported on a silica support, kept in the second reaction section 22 using a gas permeable material such as quartz wool and a gas flows through gaps in the catalyst In the apparatus, a packed quantity of the catalyst 24 is about 1 g, A packed quantity of the catalyst 24 is properly set according to a scale of the reaction apparatus or a gas flow rate to be treated. A heating furnace is provided around the second reaction section 22 in order to heat the catalyst 24 and the catalyst 24 is heated at a predetermined temperature around 300° C.

In the second reaction flow path 1b, a cooling unit 26 is installed downstream of the second reaction section 22. In the reaction section 22, CH₄ and H₂O as reaction products are generated and a gas exiting from the second reaction section 22 contains CH₄ and H₂O and unreacted CO, H₂ and CO₂, if any. The cooling unit 26 is used for removing water from the gas from the second reaction section 22.

A mass flow controller 28 is installed downstream of the cooling unit 26 for measuring a reaction product gas flow rate in the second reaction section 22. Branch flow paths are provided downstream of the mass flow controller 28, one of which is connected to a discharge port and the other of which is connected to a gas chromatograph 30 through a closing valve 29. A gas, after water is removed in the cooling unit 26, is sampled with the closing valve 29 at constant intervals or as occasion calls and components thereof are analyzed by the gas chromatograph 30.

While the gas chromatographs 16 and 30 may be separately installed, the same gas chromatograph may be used instead of the two if simultaneous use thereof can be avoided. While the gas chromatographs 16 and 30 are connected to the CO₂ removing apparatus on-line, an off-line method may be adopted in which gas samples taken through the valves 15, 29 may be measured with a gas chromatograph independent of the system.

Description will be given of operations in the CO₂ removing apparatus of the example.

A raw material gas is supplied through the valve 6 and supplied to the first reaction section 2 through the flow path 10 while being adjusted to a predetermined flow rate by the mass flow controller 8 and the reactions including the reaction formulae 1 to 3 are performed therein. The raw material gas is preferably a biogas generated by anaerobic methane fermentation of organic materials, whereas a mixed gas with a properly set compositional ratio of CH₄ to CO₂ will be used for evaluating a performance of the CO₂ removing apparatus.

A reaction product gas from the first reaction section 2 contains CO and H₂ and unreacted CH₄ and CO₂, since water is removed in the cooling unit 12. The reaction product gas is again sent to the first reaction section 2 by the action of the pump 14 and a new raw material gas is added on the way to the first reaction section 2.

When the valve 18 is opened, part of the reaction product gas from the first reaction section 2 from which water has been removed is supplied to the second reaction section 22 while being adjusted by the mass flow controller 20 to a predetermined flow rate. The reaction product gas emitted from the second reaction section 22 contains CH₄ and H₂O, and unreacted CO, H₂ and CO₂, if any, and water is removed from the reaction product gas and discharged.

Next, description will be given of an example of measurement using the CO₂ removing apparatus of the example.

### EXAMPLE 1

A raw material gas was a mixed gas with a ratio of CH₄/CO₂=80/20.

To begin with, in a state where the valve 18 between the first reaction flow path 1a and the second reaction flow path 1b was closed, the raw material gas was supplied into the first reaction flow path 1a, the gas was circulated in the flow path 10 at a gas flow rate of 1 L/min (converted to N₂) and a reaction temperature of the first reaction section 2 was raised to 600° C. to thereby perform a closed circulation reaction.

A composition of the reaction product gas was measured by the gas chromatograph 16 at intervals of 15 min and after it was confirmed that a composition of the reaction product gas in the first reaction flow path 1a was stabilized, the valve 18 was opened to cause part of the reaction product gas from the first reaction flow path 1a to flow into the second reaction flow path 1b and in this state, a reaction temperature of the reaction section 22 is raised to 300° C. and at this temperature, a composition of a reaction product gas thereof was measured by the gas chromatograph 30 at intervals of 15 min.

A flow-through gas quantity from the first reaction flow path 1a to the second reaction flow path 1b was adjusted so that a pressure in the first reaction flow path 1a was constant (in this case, the pressure was set to 0.01 MPa) when a raw material gas was supplied into the first reaction flow path 1 a at 100 ml/min.

The reaction conditions in the example are shown in Table 1 and the results are shown in Table 2. In Tables 1 and 2, “A” refers to the first reaction flow path 1a and “B” refers to the second reaction flow path 1b.

TABLE 1

| | | Supplemental | Flow path: |
|---|---|---|---|
| A | | circulation | above to below |
| Catalyst quantity | | 0.1000 | g |
| Cat⁺carbon | | — | g |
| Quartz wool g | | 1.0665 | |
| Raw material | H₂ | 0 | ml/min |
| Gas compositional ratio | N₂ | 0 | ml/min |
| | CH₄ | 80 | ml/min |
| | CO₂ | 20 | ml/min |
| Circulation gas flow rate | N₂ | 1.00 | ml/min |
| Calculated value | 0.9 | 0.90 | ml/min |
| Reaction temperature | | 600 | ° C. |
| Temperature rising speed | | — | ° C./min |
| Reaction time | | 2.75 | hr |
| Total reaction time | | 6.75 | hr |
| GC measurement | | 15 | /min |
| | | | Flow path: |
| B | | Flow-through | above to below |
| Catalyst quantity | | 1.0035 | g |
| Cat⁺carbon | | — | g |
| Quartz wool g | | 0.4169 | |
| Gas flow rate | CO₂ | 70 | ml/min |
| Calculated value | 1.22 | 85 | ml/min |
| Reaction temperature | | 300 | ° C. |
| Temperature rising speed | | — | ° C./min |
| Reaction time | | 2.25 | hr |
| Total reaction time | | 4.25 | hr |
| Reducing conditions | | 400 | ° C. |
| | | 1 | h |
| | H₂ | 100 | ml/min |
| GC measurement | | 15 | /min |
| Pressure | | 0.01 | MPa |

TABLE 2

| A Time | | | | | B Time | | | | |
|---|---|---|---|---|---|---|---|---|---|
| (min) | H₂ (%) | CH₄ (%) | CO (%) | CO₂ (%) | (min) | H₂ (%) | CH₄ (%) | CO (%) | CO₂ (%) |
| 105 | 53.96 | 37.24 | 6.43 | 1.56 | — | — | — | — | — |
| 120 | 55.06 | 36.17 | 6.73 | 1.69 | — | — | — | — | — |
| 135 | 55.62 | 35.88 | 6.64 | 1.63 | — | — | — | — | — |
| 150 | 55.97 | 35.55 | 6.67 | 1.63 | 0 | 39.34 | 59.90 | ND | 0.15 |
| 165 | 56.15 | 35.31 | 6.73 | 1.64 | 15 | 40.31 | 59.15 | ND | 0.00 |
| 180 | 56.32 | 35.13 | 6.75 | 1.64 | 30 | 40.34 | 59.16 | ND | 0.00 |
| 195 | 56.28 | 35.12 | 6.79 | 1.65 | 45 | 40.37 | 59.08 | ND | 0.05 |
| 210 | 56.33 | 35.04 | 6.82 | 1.65 | 60 | 40.22 | 59.23 | ND | 0.06 |
| 225 | 56.32 | 35.05 | 6.83 | 1.65 | 75 | 40.05 | 59.41 | ND | 0.06 |
| 240 | 56.26 | 35.03 | 6.90 | 1.66 | 90 | 39.99 | 59.46 | ND | 0.06 |
| 255 | 56.24 | 35.08 | 6.88 | 1.65 | 105 | 39.94 | 59.54 | ND | 0.06 |

In this example, when the closed circulation reaction in the first reaction flow path 1a has been performed for 150 min, it was determined that a composition of a reaction product gas in the first reaction flow path 1a was stabilized and then, the valve 18 was opened.

Compositions of the reaction product gas at time points of Table 2 were normalized so that a total molar number of a gas except N₂ was 100. From the results of Table 2, about 7% of CO and about 2% of CO₂ were contained in the reaction product gas after the CO₂ fixation reaction in the first reaction flow path 1a, while CO was contained at an extremely small quantity (ND: 100 ppm or less) on the order of a value not detected and CO₂ was reduced to a value of 0.1% or less in the reaction product gas after the methanation reaction in the second reaction flow path. From the results, with the combination of the CO₂ fixation reaction in the first reaction flow path 1a and the methanation reaction in the second reaction flow path 1b, it is confirmed that CO₂ is removed from a mixed gas of CH₄ and CO₂ such as a biogas to thereby enable the mixed gas to be converted to a hydrogen containing gas (H₂/CH₄ mixed gas).

### EXAMPLE 2

The reaction conditions for the Example 1 were maintained, and a flow-through gas quantity from the first reaction flow path 1a to the second reaction flow path 1b was adjusted so that only a supply quantity of a raw material gas to the first flow path 1a was doubled to a value of 200 ml/min with the valve 18 having been kept open and at that time, a pressure in the first reaction flow path 1a was constant at 0.01 MPa, which is the same as Example 1. The other conditions were the same as those in Example 1.

The composition “A” of the reaction product gas in the first reaction flow path 1a and the composition “B” of the reaction product gas in the second reaction flow path 2a are shown in Table 3.

TABLE 3

| A Time | | | | | B Time | | | | |
|---|---|---|---|---|---|---|---|---|---|
| (min) | H₂ (%) | CH₄ (%) | CO (%) | CO₂ (%) | (min) | H₂ (%) | CH₄ (%) | CO (%) | CO₂ (%) |
| 300 | 52.14 | 34.92 | 9.50 | 3.31 | 150 | 25.48 | 73.04 | ND | 1.14 |
| 315 | 52.42 | 33.47 | 10.31 | 3.74 | 165 | 22.02 | 75.25 | ND | 2.54 |
| 330 | 52.24 | 33.78 | 10.22 | 3.71 | 180 | 22.25 | 75.11 | ND | 2.47 |
| 345 | 52.59 | 33.36 | 10.29 | 3.70 | 195 | 22.42 | 74.84 | ND | 2.57 |
| 360 | 52.37 | 33.68 | 10.23 | 3.66 | 210 | 22.30 | 75.02 | ND | 2.50 |

According to the results shown in Table 3, in the reaction product gas composition in the first reaction flow path 1a after the CO₂ fixation reaction, about 10% of CO and about 4% of CO₂ are contained, while in the reaction product gas composition in the second reaction flow path after the methanation reaction, CO is contained at an extremely small value, which cannot be detected, and CO₂ is reduced to a value of 3% or less. Judging from the results, it is confirmed that with combination of the CO₂ fixation reaction in the first reaction flow path 1a and the methanation reaction in the second reaction flow path 1b adopted, even if a raw material gas flow rate is increased by two times of that of Example 1, conversion to a hydrogen containing gas (H₂/CH₄ mixed gas) can be realized by removing CO₂ from a mixed gas of CH₄ and CO₂ such as a biogas.

### COMPARATIVE EXAMPLE 1

A raw material gas was a mixed gas with a ratio of CH₄/CO₂=60/40.

The raw material gas was supplied into the first reaction flow path 1a to replace a gas in the flow path 10 with the raw material gas in a state where the valve 18 between the first reaction flow path 1a and the second reaction flow path 1b was closed, thereafter the valve 18 was opened and a part of a reaction product gas from the first reaction flow path 1a was caused to flow into the second reaction flow path 1b. A flow-through gas quantity from the first reaction flow path 1a to the second reaction flow path 1b is adjusted so that when the raw material gas was supplied to the first reaction flow path 1a at 100 ml/min, a pressure in the first reaction flow path 1a was kept constant at 0.01 MPa and the gas was circulated in the first reaction flow path 1a at a gas flow rate of 0.5 L/min (converted to N₂) and a reaction temperature in the first reaction section 2 was raised to 550° C.

A composition of the reaction product gas in the first reaction flow rate 1a was measured by the gas chromatograph 16 at intervals of 15 min. After stabilizing of the composition of the reaction product gas was confirmed, a reaction temperature of the second reaction section 22 was raised to 300° C. and at this temperature, a reaction gas product composition thereof was measured by the gas chromatograph 30 at intervals of 15 min.

The composition of a reaction product gas of the first reaction flow path 1a was measured at intervals of 15 min while a reaction was performed for 4 hrs in a state where a circulation gas rate in the first reaction flow path 1a is set to 1.5 L/min (converted to N₂) and during the 4 hrs of the reaction, the reaction product composition in the second reaction flow path 1b was measured at intervals of 15 min over 1 hr. The results thereof are shown in Table 4.

TABLE 4

| A Time | | | | | B Time | | | | |
|---|---|---|---|---|---|---|---|---|---|
| (h) | H₂ (%) | CH₄ (%) | CO (%) | CO₂ (%) | (h) | H₂ (%) | CH₄ (%) | CO (%) | CO₂ (%) |
| 0.00 | 15.53 | 43.02 | 13.49 | 27.96 | 0.00 | 16.31 | 47.71 | 9.01 | 26.97 |
| 0.25 | 30.18 | 33.17 | 15.42 | 21.23 | 0.25 | 4.14 | 61.84 | 0.53 | 33.49 |
| 0.50 | 30.85 | 33.81 | 14.71 | 20.63 | 0.50 | 4.02 | 62.21 | 0.51 | 33.27 |
| 0.75 | 31.07 | 34.07 | 14.39 | 20.47 | 0.75 | 3.99 | 62.20 | 0.50 | 33.31 |
| 1.00 | 31.31 | 34.10 | 14.23 | 20.35 | 1.00 | 4.03 | 62.22 | 0.50 | 33.25 |
| 1.25 | 31.61 | 33.85 | 14.21 | 20.34 | | | | | |
| 1.50 | 31.70 | 33.80 | 14.17 | 20.33 | | | | | |
| 1.75 | 31.79 | 33.79 | 14.14 | 20.29 | | | | | |
| 2.00 | 31.86 | 33.72 | 14.13 | 20.29 | | | | | |
| 2.25 | 31.92 | 33.64 | 14.14 | 20.29 | | | | | |
| 2.50 | 32.05 | 33.45 | 14.17 | 20.32 | | | | | |
| 2.75 | 32.12 | 33.39 | 14.18 | 20.31 | | | | | |
| 3.00 | 32.20 | 33.25 | 14.23 | 20.32 | | | | | |
| 3.25 | 31.95 | 32.93 | 14.17 | 20.96 | | | | | |
| 3.50 | 32.08 | 33.34 | 14.31 | 20.27 | | | | | |
| 3.75 | 32.24 | 33.21 | 14.36 | 20.19 | | | | | |
| 4.00 | 32.30 | 33.12 | 14.38 | 20.20 | | | | | |
| Average | 32.08 | 33.34 | 14.23 | 20.35 | Average | 4.01 | 62.21 | 0.50 | 33.28 |
| (2 to 4 hr) | | | | | (0.5 to 1.0 hr) | | | | |

The average (2 to 4 hrs) of Table 4 refers to the average of measured values from a time point of 2 hrs after the start to a time point of 4 hrs after the start and in a similar way, the average (0.5 to 1.0 hr) refers to the average of measured values from a time point of 0.5 hrs after the start to a time point of 1 hr after the start This applies to the following tables.

Thereafter, conditions other than a circulation gas flow rate in the first reaction flow path 1a were kept to be the same as thus far, and a circulation gas flow rate in the first reaction flow path 1a was increased to 1.0 L/min (converted to N₂), causing a reaction for 4 hrs, while a reaction product gas composition was measured at intervals of 15 min. In the second reaction flow path 1b, a reaction product gas composition was measured at intervals of 15 min over 1 hr during the 4 hr reaction. Results of the measurement are shown in Table 5.

TABLE 5

| A Time | | | | | B Time | | | | |
|---|---|---|---|---|---|---|---|---|---|
| (h) | H₂ (%) | CH₄ (%) | CO (%) | CO₂ (%) | (h) | H₂ (%) | CH₄ (%) | CO (%) | CO₂ (%) |
| 4.00 | 32.30 | 33.12 | 14.38 | 20.20 | 1.00 | 5.79 | 64.75 | 2.58 | 26.89 |
| 4.25 | 30.66 | 37.32 | 15.33 | 16.69 | 1.25 | 3.67 | 67.90 | 0.41 | 28.03 |
| 4.50 | 31.58 | 37.45 | 14.91 | 16.06 | 1.50 | 3.64 | 67.69 | 0.40 | 28.27 |
| 4.75 | 31.79 | 37.51 | 14.80 | 15.90 | 1.75 | 3.60 | 67.41 | 0.40 | 28.59 |
| 5.00 | 31.69 | 37.62 | 14.91 | 15.77 | 2.00 | 3.73 | 67.21 | 0.38 | 28.68 |
| 5.25 | 31.62 | 37.61 | 14.94 | 15.83 | | | | | |
| 5.50 | 31.50 | 37.64 | 15.04 | 15.82 | | | | | |
| 5.75 | 31.39 | 37.69 | 15.06 | 15.86 | | | | | |
| 6.00 | 31.08 | 37.56 | 15.50 | 15.86 | | | | | |
| 6.25 | 31.26 | 37.51 | 15.20 | 16.03 | | | | | |
| 6.50 | 31.18 | 37.35 | 15.41 | 16.06 | | | | | |
| 6.75 | 31.09 | 37.27 | 15.32 | 16.32 | | | | | |
| 7.00 | 30.91 | 37.31 | 15.38 | 16.40 | | | | | |
| 7.25 | 30.93 | 36.95 | 15.53 | 16.59 | | | | | |
| 7.50 | 30.81 | 37.65 | 15.32 | 16.22 | | | | | |
| 7.75 | 30.43 | 37.20 | 15.70 | 16.67 | | | | | |
| 8.00 | 30.23 | 37.28 | 15.69 | 16.80 | | | | | |
| Average | 31.20 | 37.18 | 15.20 | 16.42 | Average | 3.66 | 67.55 | 0.40 | 28.39 |
| (2 to 4 hr) | | | | | (1.25 to 2 hr) | | | | |

In this comparative example, since a ratio of CH₄ in the raw material gas was low, removal of CO₂ was incomplete as CO₂ remained at about 30% even after the methanation reaction in the second reaction flow path 1b. Further, H₂ was consumed in the methanation process of CO; therefore, a hydrogen concentration in the reaction product gas was 10% or less. Hence, new settings of reaction conditions are considered to be required so that a temperature in the CO₂ fixation reaction is raised to thereby increase a hydrogen concentration or so that a circulation flow rate is increased to thereby improve a reaction speed in the CO₂ fixation.

### COMPARATIVE EXAMPLE 2

After the measurement in Comparative Example 1, 2.00 g of a new catalyst was packed as a catalyst in the first reaction section 2, while the catalyst in the second reaction section 22 having been used in Comparative Example 1 was used again in succession. A raw material gas used was a mixed gas with a ratio of CH₄/CO₂=60/40, which is the same as in Comparative Example 1.

First, the raw material gas was supplied into the first reaction flow path 1a to replace a gas in the flow path 10 with the raw material gas in a state where the valve 18 between the first reaction flow path 1a and the second reaction flow path 1b was closed, and thereafter, the valve 18 was opened and part of a reaction product gas from the first reaction flow path 1a was caused to flow into the second reaction flow path 1b. A flow-through gas quantity from the first reaction flow path 1a to the second reaction flow path 1b was adjusted so that a pressure in the first reaction flow path 1a was kept constant at 0.01 MPa when the raw material gas was supplied into the first reaction flow path 1a at 100 ml/min, and a gas was circulated in the first reaction flow path 1a at a gas flow rate of 1.5 L/min (converted to N₂), larger than in Comparative Example 1, and a reaction temperature in the first reaction section 2 was raised to 600° C., higher than in Comparative Example 1.

A composition of a reaction product gas in the first reaction flow path 1a was measured by the gas chromatograph 16 at intervals of 15 min and after stabilizing of the composition of the reaction product gas was confirmed, a reaction temperature of the second reaction section 22 is raised to 300° C. and a reaction product gas composition of the second reaction section 22 was measured by the gas chromatograph 30 at intervals of 15 min. Results thereof are shown in Table 6.

TABLE 6

| A Time | | | | | B Time | | | | |
|---|---|---|---|---|---|---|---|---|---|
| (h) | H₂ (%) | CH₄ (%) | CO (%) | CO₂ (%) | (h) | H₂ (%) | CH₄ (%) | CO (%) | CO₂ (%) |
| 0.00 | 31.10 | 27.09 | 20.73 | 21.09 | 0.00 | 11.21 | 79.57 | 0.23 | 8.99 |
| 0.25 | 47.14 | 23.13 | 19.16 | 10.56 | 0.25 | 10.80 | 79.56 | 0.15 | 9.49 |
| 0.50 | 50.95 | 28.18 | 14.12 | 6.75 | 0.50 | 10.78 | 79.57 | 0.12 | 9.53 |
| 0.75 | 51.38 | 29.98 | 12.75 | 5.89 | 0.75 | 10.80 | 79.78 | 0.00 | 9.42 |
| 1.00 | 50.96 | 30.13 | 12.83 | 6.07 | 1.00 | 10.84 | 78.71 | 0.00 | 10.45 |
| 1.25 | 50.92 | 29.18 | 13.54 | 6.36 | 1.25 | 10.58 | 78.38 | 0.00 | 11.03 |
| 1.50 | 51.11 | 28.92 | 13.67 | 6.30 | | | | | |
| 1.75 | 51.46 | 28.80 | 13.57 | 6.17 | | | | | |
| 2.00 | 51.36 | 28.74 | 13.69 | 6.21 | | | | | |
| 2.25 | 51.33 | 28.75 | 13.74 | 6.17 | | | | | |
| 2.50 | 51.11 | 28.89 | 13.89 | 6.11 | | | | | |
| 2.75 | 50.78 | 28.74 | 14.13 | 6.34 | | | | | |
| 3.00 | 50.97 | 28.11 | 14.54 | 6.38 | | | | | |
| 3.25 | 50.26 | 27.38 | 14.49 | 7.86 | | | | | |
| 3.50 | 51.15 | 27.54 | 14.98 | 6.33 | | | | | |
| 3.75 | 51.29 | 27.68 | 14.96 | 6.07 | | | | | |
| 4.00 | 51.58 | 27.67 | 14.88 | 5.87 | | | | | |
| Average | 51.09 | 28.17 | 14.37 | 6.37 | Average | 10.76 | 79.20 | 0.06 | 9.99 |
| (2 to 4 hr) | | | | | (0.25 to 1.25 hr) | | | | |

Since clogging by deposited carbon occurs in the first reaction section 2 and the circulation flow rate was unable to be maintained, the reaction was terminated 4 hrs after the start After the reaction, the carbon was taken out, which weighed 9.47 g (2.37/h). A reaction product gas flow rate after the methanation reaction was 31 ml/min.

Carbon monoxide was almost removed as compared with the case of Comparative Example 1, but CO₂ still remained at a concentration of around 10%. A hydrogen concentration in the reaction product gas after the methanation reaction is around 10%, which was not a great change as compared with the case of Comparative Example 1. Since it is thought that the CO₂ fixation reaction temperature in the reaction section 2 is difficult to be raised to a higher temperature, it is likely to be necessary to increase a circulation flow rate to thereby enhance a CO₂ fixation reaction speed or to set reaction conditions so as to decrease a supply gas quantity.

### EXAMPLE 3

Next, description will be given of an example using Co in place of Ni as a catalyst component

A CO₂ removing apparatus used for this example was the apparatus shown in FIG. 1, which was the same as in Example 1 except for the catalyst component That is, catalysts 4 and 24 are Co/SiO₂ catalyst with a structure in which Co as a catalyst component is supported on a silica support and was kept in the reaction section using a permeable material such as quartz wool and a gas flows through gaps in the catalyst A packed quantity of the catalyst was similar to that in Example 1.

A raw material gas was a mixed gas with a ratio of CH₄/CO₂=3/2.

At first, with the valve 18 between the first and second reaction flow paths shut, the raw material gas was supplied to the first reaction flow path 1a and circulated in the flow path 10 at a gas flow rate 5 L/min (converted to N₂) to thereby cause a closed circulation reaction at a temperature of 600° C. in the first reaction section 2.

A composition of a reaction product gas in the first reaction flow path 1a was measured at intervals of 15 min by the gas chromatograph 16. After stabilizing of the composition was confirmed, the valve 18 was opened to cause part of the reaction product gas from the first reaction flow path 1a to flow into the second reaction flow path 1b, a reaction temperature in the second reaction section 22 was raised to 300° C., and then a composition of a reaction product gas from the second reaction section 22 was measured at intervals of 15 min by the gas chromatograph 30.

A flow-through gas quantity from the first reaction flow path 1a to the second reaction flow path 1b was adjusted so that a pressure in the first reaction flow path 1a was kept constant (in this case, the pressure was set to 0.01 MPa) when the raw material gas was supplied into the first reaction flow path 1a at 80 ml/min.

Results of the example are shown in Table 7. “A” refers to the first reaction flow path 1a and “B” refers to the second reaction flow path 1b.

TABLE 7

| A Time | | | | | B Time | | | | |
|---|---|---|---|---|---|---|---|---|---|
| (h) | H₂ (%) | CH₄ (%) | CO (%) | CO₂ (%) | (h) | H₂ (%) | CH₄ (%) | CO (%) | CO₂ (%) |
| 0.00 | 28.29 | 26.23 | 21.11 | 24.37 | | | | | |
| 0.25 | 39.55 | 24.21 | 18.43 | 17.81 | | | | | |
| 0.50 | 48.25 | 33.61 | 13.99 | 4.15 | | | | | |
| 0.75 | 49.21 | 39.88 | 7.22 | 3.69 | | | | | |
| 1.00 | 49.23 | 39.88 | 7.15 | 3.74 | 0.00 | 18.42 | 79.88 | 0.66 | 1.04 |
| 1.25 | 49.24 | 39.93 | 7.16 | 3.67 | 0.25 | 17.93 | 81.15 | 0.03 | 0.89 |
| 1.50 | 49.24 | 39.90 | 7.15 | 3.71 | 0.50 | 18.07 | 81.23 | 0.01 | 0.69 |
| 1.75 | 49.20 | 38.69 | 7.10 | 5.01 | 0.75 | 18.08 | 81.22 | 0.00 | 0.70 |
| 2.00 | 41.35 | 38.12 | 7.08 | 13.45 | 1.00 | 17.77 | 81.43 | 0.00 | 0.80 |
| Average | 47.65 | 39.30 | 7.13 | 5.92 | Average | 18.05 | 80.98 | 0.14 | 0.82 |
| (1 to 2 hr) | | | | | (0 to 1 hr) | | | | |

It was determined that composition of a reaction product gas in the reaction flow path 1a was stabilized when the closed circulation reaction in the first reaction flow path 1a was performed for 60 minutes and then, the valve 18 was opened.

The compositions of the reaction product gases at time points of Table 7 were normalized so that a total molar number of gases except N₂was 100. From the results of Table 7, the reaction product gas in the first reaction flow path 1a, after the CO₂ fixation reaction, contains CO at about 7% and CO₂ at about 6%, while the reaction product gas in the second reaction flow path 1b after the methanation reaction contains almost no CO and CO₂ at a reduced concentration of 1% or less.

It is confirmed that even in a case where Co was used as a catalyst, a mixed gas of CH₄ and CO₂ such as a bio gas was able to be converted to a hydrogen containing gas (H₂/CH₄ mixed gas) by removing CO₂ from the mixed gas of CH₄ and CO₂ with the combination of the CO₂ fixation reaction in the first reaction flow path 1a and the methanation reaction in the second reaction flow path 1b adopted.

Carbon dioxide is removed from a mixed gas containing CH₄ and CO₂ such as a biogas generated by anaerobic methane fermentation of organic materials to thereby extract methane, which can be used as materials for organic synthesis, for hydrogen production used in a fuel cell, and a fuel.

What is claimed is:

1. A CO₂ removing method for removing CO₂ found in a raw material gas containing at least CH₄ and CO₂, comprising the following processes of
(A) a first reaction process to constitute a circulation flow path including:
a step of supplying the raw material gas to a first reaction section heated in the presence of a catalyst containing a transition metal as a catalyst active component;
a step of removing H₂O from a mixed gas which is a reaction product in the first reaction section; and
a step of mixing the mixed gas from which H₂O has been removed with the raw material gas, into the first reaction section, and.
(B) a second reaction process in which part of the mixed gas is taken out downstream of the first reaction section and supplied into a second reaction section heated in the presence of another catalyst containing a transition metal as a catalyst active component to thereby react CO₂ and CO with H₂ in the mixed gas to convert CO₂ and CO to CH₄.

2. The CO₂ removing method according to claim 1, wherein
the mixed gas of the reaction product in the first reaction section, from which H₂O has been removed, is a mixed gas containing CH₄, H₂, CO and CO₂.

3. The CO₂ removing method according to claim 1, wherein
the mixed gas to be supplied into the second reaction section is the mixed gas of the reaction product in the first reaction section from which H₂O has been removed.

4. The CO₂ removing method according to claim 1, wherein the catalyst active component is at least one kind selected from the group consisting of Fe, Co and Ni.

5. The CO₂ removing method according to claim 1, wherein the raw material gas is a biogas generated by anaerobic methane fermentation of organic materials.

6. A CO₂ removing apparatus comprising
a first reaction flow path including a first reaction section in which a supplied gas is heated in the presence of a catalyst containing a transition metal as a catalyst active component to cause a reaction; a raw material gas supply section for supplying a raw material gas containing at least CH₄ and CO₂ to the first reaction section; a cooling unit disposed downstream of the first reaction section and removing H₂O from a mixed gas, which is a reaction product in the first reaction section; and a circulation flow path for mixing the mixed gas passing through the cooling unit with the raw material gas and for again supplying the mixed gas to the first reaction section; and
a second reaction flow path being connected to the first reaction flow path so that part of the mixed gas, which is a reaction product in the first reaction flow path, is supplied thereto, and including a second reaction section that is heated in the presence of another catalyst containing a transition metal as a catalyst active component to thereby react CO₂ and CO with H₂ in the mixed gas and to convert CO₂ and CO to CH₄.

7. The CO₂ removing apparatus according to claim 6, wherein the mixed gas which is a reaction product in the first reaction section is a mixed gas containing CH₄, CO₂, H₂, CO, and H₂O.

8. The CO₂ removing apparatus according to claim 6, wherein the second reaction flow path is connected to a position downstream of the cooling unit of the first reaction flow path and upstream of a merging section of the first reaction flow path with the raw material gas supplying section.

9. The CO₂ removing apparatus according to claim 6, wherein the catalyst active components are at least one kind selected from the group consisting of Fe, Co and Ni.

10. The CO₂ removing apparatus according to claim 6, wherein the raw material gas is a biogas generated by anaerobic methane fermentation of organic materials.
